(19) United States
(12) Patent Application Publication
(10) Pub. No.: US 2025/0364938 A1
(43) Pub. Date: Nov. 27, 2025

(54) APPARATUS AND METHOD FOR SYNCHRONOUSLY CONTROLLING 6-PHASE MOTOR BY USING DUAL CONTROLLER

(71) Applicant: HYUNDAI AUTOEVER CORP., Seoul (KR)

(72) Inventor: Eun Su Jun, Seoul (KR)

(73) Assignee: HYUNDAI AUTOEVER CORP., Seoul (KR)

(21) Appl. No.: 19/215,016

(22) Filed: May 21, 2025

(30) Foreign Application Priority Data
May 22, 2024 (KR) 10-2024-0066547

(51) Int. Cl. H02P 27/14; H02P 25/024

(52) U.S. Cl. CPC H02P 27/14; H02P 25/024

(57) ABSTRACT

An apparatus for synchronously controlling a 6-phase motor includes: a first controller configured to calculate a length of a next switching pulse-width modulation (PWM) period, output at least one PWM signal indicating a length value of the next switching PWM period, and control abc phases of the 6-phase motor by using a control duty for the abc phases and the length value of the next switching PWM period. The apparatus also includes a second controller configured to obtain the length value of the next switching PWM period according to the at least one PWM signal, and control xyz phases of the 6-phase motor by using a control duty for the xyz phases and the length value of the next switching PWM period.

### CROSS-REFERENCE TO RELATED APPLICATION

This application claims the benefit of and priority to Korea Patent Application No. 10-2024-0066547, filed on May 22, 2024, the entire contents of which are hereby incorporated herein by reference.

### FIELD OF TECHNOLOGY

The present disclosure relates to technology for controlling a motor.

### BACKGROUND

Urban air mobility (UAM), which refers to flying vehicles, is currently receiving significant attention globally as one of the fields with bright prospects for next-generation industries. This technology is regarded as an innovative solution that offers a fast and efficient means of urban transportation, thereby reducing traffic congestion and shortening travel times. It is anticipated that more rapid and flexible urban mobility will be enabled by overcoming the limitations of traditional ground transportation and by utilizing aerial travel routes.

UAM refers to a service that transports people or goods via small aircrafts that use electric or hybrid power. This may be utilized not only for short-distance urban travel but also as a rapid means of transportation to suburban areas, and it holds significant potential, particularly in regions with insufficient transportation infrastructure. While the development of the UAM industry presents the task of addressing various technical, regulatory, and social challenges, it is anticipated to become a crucial component of future transportation systems, as numerous companies and governments are expanding research and investment in this area.

The advancement and commercialization of UAM technology are anticipated not only to fundamentally transform the urban transportation paradigm but also to fulfill a role as an eco-friendly means of transportation. This is because the primary use of electric power reduces carbon emissions while enabling significantly more efficient travel compared to conventional road traffic. Consequently, UAM is regarded as a vital technology for sustainable urban development and transportation system innovation, and it is anticipated that its potential may be witnessed in actual urban environments within the next few years.

On the other hand, while the UAM system is an innovative transportation solution, it entails inherent risks associated with its operational environment. Owing to the nature of flying vehicles, a failure in such a vehicle may lead to extremely severe consequences. For example, in the case of an automobile, even when an issue such as a motor controller malfunction occurs, the vehicle may be able to stop safely on the road. Even when a system failure occurs, because the vehicle may still be controlled by using its chassis and wheels, a relatively safe situation may be maintained for the driver, passengers, and other road users.

In contrast, UAM vehicles are significantly more vulnerable to issues that may occur during flight, such as a motor controller malfunction. Flying vehicles require continuous power and control, and when any one of these critical systems fails, the vehicle may become unable to remain airborne, potentially leading directly to a crash. Such a crash may pose a severe risk not only to the occupants but also to individuals on the ground. Consequently, the safety of UAM vehicles is paramount, and to this end, it is essential to develop and implement various safety devices and protocols, such as multi-redundant systems, fault-tolerant systems, or emergency response protocols.

The discussions in this section are intended merely to provide background information and do not constitute an admission of prior art.

### SUMMARY

An embodiment of the present disclosure provides technology for safely controlling a motor. Another embodiment of the present disclosure provides technology for controlling a 6-phase motor by using a dual controller to enhance safety. An embodiment of the present disclosure provides technology for enabling controllers of a dual controller for controlling a 6-phase motor to be synchronized with each other.

According to an embodiment, an apparatus for controlling a 6-phase motor is provided. The 6-phase motor synchronous control apparatus includes a first controller configured to calculate a length of a next switching pulse-width modulation (PWM) period, output at least one PWM signal indicating a length value of the next switching PWM period, and control abc phases of the 6-phase motor by using a control duty for the abc phases and the length value of the next switching PWM period. The apparatus also includes a second controller configured to obtain the length value of the next switching PWM period according to the at least one PWM signal, and control xyz phases of the 6-phase motor by using a control duty for the xyz phases and the length value of the next switching PWM period.

The first controller may divide the length value of the next switching PWM period into lower bit values and upper bit values, output a first PWM signal indicating the lower bit values, and output a second PWM signal indicating the upper bit values.

The second controller may extract an A value from the first PWM signal, extract a B value from the second PWM signal, and obtain the length value of the next switching PWM period by performing an OR operation between a value resulting from a bit shift operation on the B value, and the A value.

The first controller and the second controller may output a switching PWM signal by using an up-down counter configured to increment and then decrement in a switching PWM period, and a register that indicates an edge value.

In the first controller and the second controller, the up-down counter may switch a counting direction from incrementing to decrementing, according to a master PWM signal that indicates a control period of the first controller.

A next control period of the first controller may be calculated as a sum of one-half of a length of the current switching PWM period and one-half of a length of the next switching PWM period.

The first controller may output the at least one PWM signal by using a timer output module (TOM), and the second controller may extract data for calculating the length value of the next switching PWM period, from the at least one PWM signal by using a timer input module (TIM).

The TIM of the second controller may generate an interrupt service routine (ISR) event according to a master PWM signal or the at least one PWM signal received from the first controller, and the second controller may calculate the length of the next switching PWM period, from the data extracted from the at least one PWM signal, according to the ISR event.

According to another embodiment, a method for synchronously controlling a 6-phase motor is provided. The method includes calculating a length of a next switching PWM period and outputting at least one PWM signal indicating a length value of the next switching PWM period, The method also includes controlling abc phases of a 6-phase motor by using a control duty for the abc phases and the length value of the next switching PWM period; obtaining the length value of the next switching PWM period according to the at least one PWM signal. The method additionally includes controlling xyz phases of the 6-phase motor by using a control duty for the xyz phases and the length value of the next switching PWM period.

Outputting the at least one PWM signal indicating the length value of the next switching PWM period may include outputting a first PWM signal to correspond to a value resulting from an operation between the length value of the next switching PWM period and 0xFF, and outputting a second PWM signal to correspond to a value resulting from an operation between the length value of the next switching PWM period and 0xFF00.

Obtaining the length value of the next switching PWM period according to the at least one PWM signal may include extracting an A value from the first PWM signal, extracting a B value from the second PWM signal, and calculating the length value of the next switching PWM period by performing a bitwise operation of (B<<8)|A.

The method may further include calculating a length of a next control period as a sum of one-half of a length of a current switching PWM period and one-half of the length of the next switching PWM period.

Controlling the xyz phases may include outputting a switching PWM signal by using an up-down counter configured to increment and then decrement in a switching PWM period, and a register that indicates an edge value, and switching a counting direction of the up-down counter from incrementing to decrementing, at an end point or a start point of the control period.

The method may further include outputting a master PWM signal in synchronization with the control period. Controlling the xyz phases may further include switching the counting direction of the up-down counter from incrementing to decrementing, according to the master PWM signal.

According to yet another embodiment, another apparatus for synchronously controlling a 6-phase motor is provided. The apparatus includes a first controller configured to control abc phases of the 6-phase motor by using a control duty for the abc phases and a length value of a next switching PWM period, and output the length value of the next switching PWM period by using a TOM. The apparatus also includes a second controller configured to obtain the length value of the next switching PWM period by using a TIM configured to receive an output of the TOM as an input, and control xyz phases of the 6-phase motor by using a control duty for the xyz phases and the length value of the next switching PWM period.

The second controller may calculate a rising edge tick value or a falling edge tick value of a switching PWM signal by using the control duty for the xyz phases and the length value of the next switching PWM period.

The second controller may output the switching PWM signal by using an up-down counter configured to increment and then decrement in a switching PWM period, and a register that indicates the rising edge tick value or the falling edge tick value.

The first controller may further output a control period by using the TOM, and the second controller may switch a counting direction of the up-down counter from incrementing to decrementing, at an end point or a start point of the control period, which is identified by the TIM.

An ISR event corresponding to the end point or the start point of the control period may be generated by the TIM in the second controller.

The first controller may output the length value of the next switching PWM period, as a plurality of PWM signals by using the TOM.

As described above, according to embodiments of the present disclosure, a motor may be controlled more safely. In addition, according to embodiments of the present disclosure, by controlling a 6-phase motor via a dual controller, the safety of 6-phase motor control may be further enhanced. In addition, according to embodiments of the present disclosure, the synchronization problem, a challenge associated with a dual controller, may be addressed.

### BRIEF DESCRIPTION OF THE DRAWINGS

FIG. 1 is a configuration diagram illustrating an example of a system for controlling a 6-phase motor.

FIG. 2 is a diagram illustrating a configuration of a 6-phase motor control system according to an embodiment.

FIG. 3 is a diagram illustrating configurations of inverters and a motor, according to an embodiment.

FIG. 4 is a diagram illustrating generating switching PWM signals in accordance with a control duty.

FIG. 5 is a diagram illustrating key waveforms of controllers in a 6-phase motor synchronous control apparatus, according to an embodiment.

FIG. 6 is a flowchart of a 6-phase motor synchronous control method according to an embodiment.

FIG. 7 is a flowchart of a control method for a first controller, according to an embodiment.

FIG. 8 is a flowchart of a control method for a second controller, according to an embodiment.

FIG. 9 is a diagram illustrating signals between a first controller and a second controller, according to an embodiment.

### DETAILED DESCRIPTION

Hereinafter, some embodiments of the present disclosure are described in detail with reference to accompanying diagrams. It should be noted that in assigning reference numerals to components in the accompanying drawing, identical components are designated with the same reference numerals whenever possible, even when the components are illustrated in different drawings. Furthermore, in the description of the present disclosure, where it was determined that a detailed description of related known configurations or functions would obscure the gist of the present disclosure, a detailed description thereof has been omitted.

In addition, in describing components of the present disclosure, expressions such as “first”, “second”, “A”, “B”, “(a)”, or “(b)” may be used. These expressions are only intended to distinguish one component from another, and do not limit the nature, order, or sequence of the components. It should be understood that, when it is described that a first element is “connected,” “coupled,” or “joined” to a second element, the first element may be directly connected, coupled, or joined to the second element, or the first element may be connected, coupled, or joined to the second element with a third element connected, coupled, or joined therebetween.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

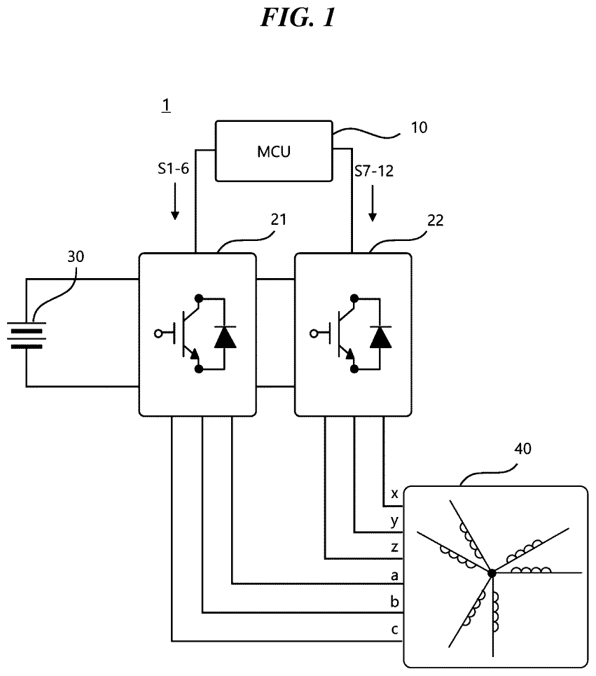

FIG. 1 is a configuration diagram illustrating an example of a system for controlling a 6-phase motor.

Referring to FIG. 1, a motor 40 may have six phases.

The 6-phase motor 40 may include two three-phase systems. The three-phase systems may be respectively designated as a set of abc phases and a set of xyz phases. In the 6-phase motor 40, the abc phases and the xyz phases may be arranged with certain angular displacements relative to each other. For example, in a case in which the abc phases are arranged at 120-degree intervals, similar to a standard three-phase system, the xyz phases may be arranged at a specific angle, such as 30 degrees or 60 degrees, relative to the abc phases. With this arrangement, the motor may achieve smoother rotational torque and higher-resolution control. Furthermore, in the event of a fault, other phases may continue operation, thereby offering enhanced reliability.

A system 1 for controlling a 6-phase motor may include two inverters 21 and 22, a controller 10 (e.g., a motor control unit (MCU)), a power supply 30, and the like.

The first inverter 21 of the two inverters 21 and 22 may supply power to control the abc phases of the 6-phase motor 40. The output of the first inverter 21 may be connected to the abc phases of the 6-phase motor 40, and the first inverter 21 may control the abc phases by supplying phase power to each of the abc phases. The second inverter 22 of the two inverters 21 and 22 may supply power to control the xyz phases of the 6-phase motor 40. The output of the second inverter 22 may be connected to the xyz phases of the 6-phase motor 40, and the second inverter 22 may control the xyz phases by supplying phase power to each of the xyz phases.

A plurality of switches may be arranged in each of the inverters 21 and 22. The controller 10 may output switching pulse-width modulation (PWM) signals S1 to S6 and S7 to S12 for controlling the on/off operation of these switches. Then, in accordance with these switching PWM signals, each of the inverters 21 and 22 may turn the switches on/off to convert power supplied from the power supply 30 into phase power appropriate for respective phases.

The controller 10 may output first switching PWM signals S1 to S6 to control the switches included in the first inverter 21, and may output second switching PWM signals S7 to S12 to control the switches included in the second inverter 22.

Because a single controller 10 is arranged in the system 1 for controlling a 6-phase motor, synchronization between the first switching PWM signals S1 to S6 and the second switching PWM signals S7 to S12 may not pose a problem. A single controller 10 may generate the first switching PWM signals S1 to S6 and the second switching PWM signals S7 to S12 such that the signals are synchronized with each other.

While the use of a single controller 10 is advantageous for controlling different inverters with synchronized signals, a problem arises in that when the controller 10 malfunctions, the entire system may fail to operate. Consequently, a 6-phase motor control system according to an embodiment proposes a technology for controlling a 6-phase motor by using a dual controller.

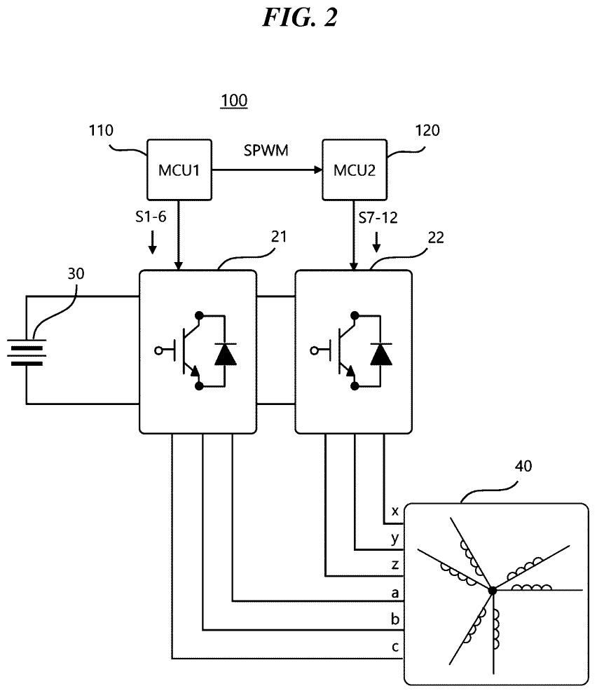

FIG. 2 is a diagram illustrating a configuration of a 6-phase motor control system according to an embodiment.

Referring to FIG. 2, a 6-phase motor control system 100 may include a first controller 110, a second controller 120, the first inverter 21, the second inverter 22, the power supply 30, and the like.

The first controller 110 may control the abc phases of the 6-phase motor 40 by outputting first switching PWM signals S1 to S6 capable of performing on/off control of the switches included in the first inverter 21.

In addition, the second controller 120 may control the xyz phases of the 6-phase motor 40 by outputting second switching PWM signals S7 to S12 capable of performing on/off control of the switches included in the second inverter 22.

The first controller 110 and the second controller 120 may each be a hardware component known as an MCU. The abbreviation ‘MCU’ may stand for ‘microcontroller unit’ or ‘motor control unit’.

The MCUs 110 and 120 may be suitable for outputting PWM signals. The MCUs 110 and 120 may generate switching PWM signals to control the speed and torque of a motor. The switching PWM signals enable precise adjustment of power supplied to the motor 40 by modulating the average values of voltage and current of each phase power converted in the inverters 21 and 22.

The MCUs 110 and 120 may each include an analog-to-digital converter (ADC) for converting analog signals from the motor 40, such as a current, a voltage, or a temperature, into digital values. The MCUs 110 and 120 may each include an ADC that has a high sampling rate and high resolution for precise motor control.

The MCUs 110 and 120 may each be equipped with a multi-core central processing unit (CPU). By using such a CPU, the MCUs 110 and 120 may perform calculations for control and execute complex algorithms.

The MCUs 110 and 120 may each include a timer and a counter. By using these timers and counters, the MCUs 110 and 120 may accurately control the timing of PWM signals.

The MCUs 110 and 120 may each include flash memory and random-access memory (RAM), for storing program code and data.

The first controller 110 and the second controller 120, that may incorporate such MCU components, may be implemented as mutually separate hardware entities that do not share memory. The first controller 110 and the second controller 120 may include independent CPUs and independent timers and counters. In some embodiments, the first controller 110 and the second controller 120 may be implemented as independent hardware units that do not share memory.

The first controller 110 and the second controller 120 may exchange synchronization signals to synchronize the switching PWM signals S1 to S6 and S7 to S12. For example, the first controller 110 may synchronize the switching PWM signals S1 to S6 and S7 to S12 by transmitting at least one PWM signal SPWM to the second controller 120.

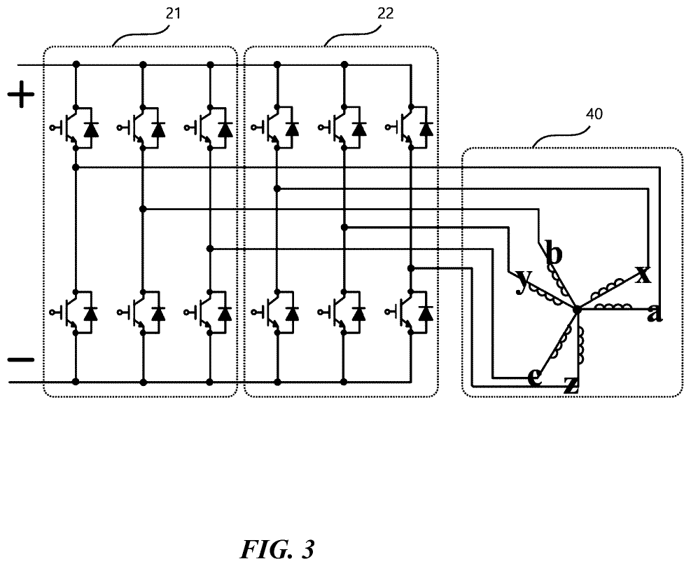

FIG. 3 is a diagram illustrating configurations of inverters and a motor, according to an embodiment.

Referring to FIG. 3, the first inverter 21 may include six switches, and the second inverter 22 may include six switches.

The upper switches of the first inverter 21 may have sides connected to the positive electrode of a power supply, and opposite sides respectively connected to the a, b, and c phases of the motor 40. Similarly, the lower switches of the first inverter 21 may have sides connected to the negative electrode of the power supply, and opposite sides respectively connected to the a, b, and c phases of the motor 40. One upper switch and one lower switch connected to the same phase form one arm, and when, in this arm, the upper switch is turned on and the lower switch is turned off, a positive voltage from the power supply is supplied to the corresponding phase. In addition, when, in this arm, the upper switch is turned off and the lower switch is turned on, a negative voltage from the power supply is supplied to the corresponding phase.

The upper switches of the second inverter 22 may have sides connected to the positive electrode of the power supply, and opposite sides respectively connected to the x, y, and z phases of the motor 40. Similarly, the lower switches of the second inverter 22 may have sides connected to the negative electrode of the power supply, and opposite sides respectively connected to the x, y, and z phases of the motor 40. One upper switch and one lower switch connected to the same phase form one arm, and when, in this arm, the upper switch is turned on and the lower switch is turned off, a positive voltage from the power supply is supplied to the corresponding phase. In addition, when, in this arm, the upper switch is turned off and the lower switch is turned on, a negative voltage from the power supply is supplied to the corresponding phase.

The average voltage and/or average current flowing in each phase may be determined by the proportion of the time during which a positive voltage is supplied within one switching PWM period (i.e., the control duty). The first controller and the second controller may supply switching PWM signals to the respective inverters 21 and 22 to control the average voltage and/or average current supplied to each phase within one switching PWM period. herein an embodiment, the switching PWM signals may be determined by a control duty that is determined according to a control algorithm (e.g., a control loop).

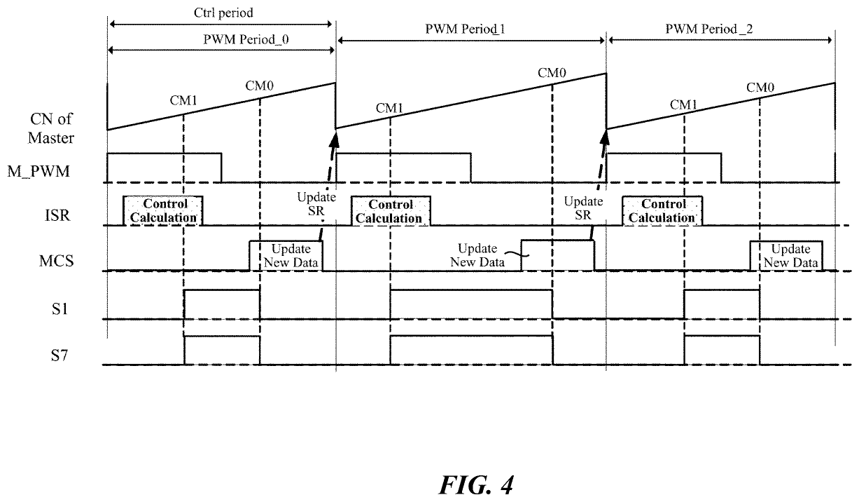

FIG. 4 is a diagram illustrating generating switching PWM signals in accordance with a control duty.

Referring to FIG. 4, a controller may calculate a control duty for each control period Ctrl Period. The controller may control each phase of the motor by generating switching PWM signals S1 and S7 for each switching PWM period PWM Period.

The controller may include an up-counter CN. The up-counter CN may increment its value from a reset value at regular time intervals. The up-counter CN may be reset at a predetermined time point or in synchronization with a reset signal from another channel.

When the up-counter CN is reset, an interrupt service routine (ISR) event occurs, and in a function that processes the ISR event, the control duty for the next switching PWM period may be calculated for each control period. In an embodiment, when necessary, a length value of the next switching PWM period may also be calculated. Then, when the control duty and the length value of the next switching PWM period are determined, rising edge values and falling edge values of the switching PWM signals S1 and S7 may be calculated as time values (e.g., tick values). For example, when the length value of the next switching PWM period is 10,000 ticks and the control duty is 0.6, the rising edge value may be determined as 2,000 ticks, and the falling edge value may be determined as 8,000 ticks.

The controller may include a multichannel sequencer (MCS). The MCS may update a register with the calculated rising edge value and/or falling edge value. The controller may include a synchronization register (SR), a control mode (CM) register, and the like. The controller may update these registers with a rising edge value and/or a falling edge value.

When the value of the up-counter CN reaches a value stored in a first register CM1, the controller may generate rising edges of the switching PWM signals S1 and S7. In addition, when the value of the up-counter CN reaches a value stored in a second register CM0, the controller may generate falling edges of the switching PWM signals S1 and S7.

In the above-described example, the control period Ctrl Period and the switching PWM period PWM Period may be identical to each other, and these periods may be synchronized with a master PWM signal M_PWM.

In order for the controller to generate switching PWM signals as described above, the length value of the switching PWM period, in addition to the control duty, may be required. In a motor control apparatus employing two controllers, the controllers may determine control duties according to control algorithms included in the respective controllers. However, in a case in which two controllers need to be synchronized, such as for a 6-phase motor, although each controller may determine its control duty independently, the switching PWM periods need to be synchronized. Here, the two controllers need to not only synchronize the switching PWM periods but also know in advance the length value of the next switching PWM period. The controller may calculate a rising edge value and/or a falling edge value for a switching PWM signal in the next switching PWM period only after the length value of the next switching PWM period has been determined.

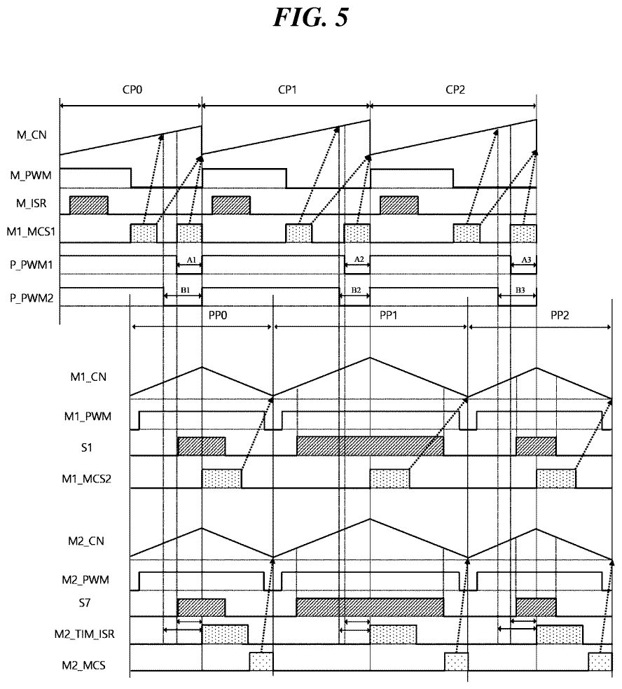

FIG. 5 is a diagram illustrating key waveforms of controllers in a 6-phase motor synchronous control apparatus, according to an embodiment.

Referring to FIG. 5, the 6-phase motor synchronous control apparatus may include a first controller M1 and a second controller M2 constituting a dual controller. In an embodiment, the first controller M1 may operate as a master controller M.

The first controller M1 may perform up-counting by using a master counter M_CN. An interval from when the master counter M_CN commences counting until the master counter M_CN is reset may be defined as a control period Ctrl Period (CP). FIG. 5 illustrates an initial control period CP0, a first control period CP1, and a second control period CP2.

The first controller M1 may generate a master PWM signal M_PWM that is synchronized with the master control periods CP0, CP1, and CP2. The duty cycle of the master PWM signal M_PWM may be 0.5.

In a function that processes a master ISR event M_ISR, which occurs based on the start or reset timing of the master PWM signal M_PWM or the master control periods CP0, CP1, and CP2, the first controller M1 may calculate the length of the next switching PWM period, and may calculate a rising edge value and/or a falling edge value for control in the next switching PWM period, according to a control duty determined by a control algorithm and the length value of the next switching PWM period.

In addition, in the function that processes the master ISR event M_ISR, the first controller M1 may calculate an A value A1, A2, or A3 and a B value B1, B2, or B3 for generating one or more PWM signals P_PWM1 and P_PWM2. Here, the one or more PWM signals P_PWM1 and P_PWM2 may be signal that indicate the length value of the next switching PWM period.

The first controller M1 may divide the length value of the next switching PWM period into lower bit values and upper bit values, then calculate the A value from the lower bit values, and may calculate the B value from the upper bit values. For example, in a case in which the length value of the next switching PWM period is a 16-bit value, the first controller M1 may calculate, as the A value A1, A2, or A3, a value resulting from an AND operation between the length value of the next switching PWM period and 0xFF, and may calculate the B value B1, B2, or B3 to correspond to a value resulting from an AND operation between the length value of the next switching PWM period and 0xFF00 (the B value may be a 8-bit value after a bit shift operation).

Then, the first controller M1 may update the CM0 register with the calculated A value A1, A2, or A3 and B value B1, B2, or B3, by using a first-1 MCS M1_MCS1.

The value updated in the CM0 register may be compared with the master counter M_CN and when the master counter M_CN reaches the value in the register CM0, a falling edge of the first PWM signal P_PWM1 may be formed, and a falling edge of the second PWM signal P_PWM2 may be formed. Here, there may be two CM0 registers, and the A value A1, A2, or A3 and the B value B1, B2, or B3 may be stored in the respective CM0 registers.

According to this process, the first PWM signal P_PWM1 may represent the lower bit values of the length value of the next switching PWM period, and the second PWM signal P_PWM2 may represent the upper bit values of the length value of the next switching PWM period.

The first controller M1 may include a timer output module (TOM). In addition, the first controller M1 may output the master PWM signal M_PWM, the first PWM signal P_PWM1, and the second PWM signal P_PWM2, by using the TOM.

The first controller M1 and the second controller M2 may respectively include up-down counters M1_CN and M2_CN that increment and then decrement in each of switching PWM periods PP0, PP1, and PP2.

The up-down counters M1_CN and M2_CN may start counting upward from an initial value at the start point of each of the switching PWM periods PP0, PP1, and PP2. Then, the up-down counters M1_CN and M2_CN may change their counting direction from incrementing to decrementing in accordance with the master PWM signal M_PWM, which indicates the control periods CP0, CP1, and CP2 of the first controller M1. In addition, a time interval, during which the up-down counters M1_CN and M2_CN increment from the initial value and then decrement to reach the initial value again, may represent a switching PWM period.

The control periods CP0, CP1, and CP2 may differ from the switching PWM periods PP0, PP1, and PP2. The first controller M1 may calculate the length of the next control period, as the sum of one-half of the length of the current switching PWM period and one-half of the length of the next switching PWM period (this calculation may be performed in an M_ISR event processing function in FIG. 5). In addition, the first controller M1 may update, by using the first-1 MCS M1_MCS1, a register (e.g., an SR register) with the length of the next control period, such that the master counter M_CN is reset in the next control period when its count reaches the length value of the next control period.

In the function that processes the master ISR event M_ISR, the first controller M1 may calculate a rising edge value and/or a falling edge value for control in the next switching PWM period, based on the control duty and the length value of the next switching PWM period. In an embodiment, the first controller M1 may calculate a single edge value that is comparable with the first up-down counter M1_CN. Then, the first controller M1 may update the CM1 register with this edge value, by using a first-2 MCS M1_MCS2.

In addition, the first controller M1 may generate a rising edge of the switching PWM signal S1 when the value of the first up-down counter M1_CN, while incrementing, reaches the edge value, and may generate a falling edge of the switching PWM signal S1 when the value of the first up-down counter M1_CN, while decrementing, reaches the edge value.

The second controller M2 may include a timer input module (TIM).

The second controller M2 may receive, by using the TIM, PWM signals output from the TOM of the first controller M1, and may extract, from the PWM signals, data for calculating the length value of the next switching PWM period.

By using the TIM, the second controller M2 may calculate the A value A1, A2, or A3 included in the first PWM signal P_PWM1, and may calculate the B value B1, B2, or B3 included in the second PWM signal P_PWM2. Then, the second controller M2 may calculate the length value of the next switching PWM period, by using the A value A1, A2, or A3 and the B value B1, B2, or B3. For the length value calculation, the second controller M2 may calculate the length value of the next switching PWM period by performing an OR operation between a value resulting from a bit shift operation on the B value B1, B2, or B3, and the A value. For example, the second controller M2 may calculate the length value of the next switching PWM period by performing a bitwise operation of (B<<8)|A.

The TIM may generate an ISR event based on a received master PWM signal M_PWM or first PWM signal P_PWM1/second PWM signal P_PWM2. In a function that processes this ISR event M2 TIM ISR, the second controller M2 may calculate the length value of the next switching PWM period, and may calculate a rising edge value and/or a falling edge value for control, by using the control duty and the length value of the next switching PWM period.

In an embodiment, the second controller M2 may calculate a single edge value that is comparable with the second up-down counter M2_CN. Then, the second controller M2 may update the CM1 register with this edge value, by using a second MCS M2 MCS.

In addition, the second controller M2 may generate a rising edge of the switching PWM signal S7 when the value of the second up-down counter M2_CN, while incrementing, reaches the edge value, and may generate a falling edge of the switching PWM signal S7 when the value of the second up-down counter M2_CN, while decrementing, reaches the edge value.

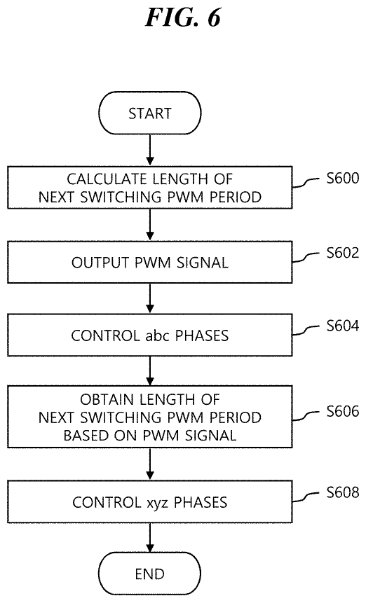

FIG. 6 is a flowchart of a 6-phase motor synchronous control method according to an embodiment.

Referring to FIG. 6, in an operation S600, a control apparatus may calculate the length of the next switching PWM period.

In an operation S602, the control apparatus may output at least one PWM signal that indicates the length value of the next switching PWM period.

In an operation S604, the control apparatus may control the abc phases of the 6-phase motor by using the control duty for the abc phases and the length value of the next switching PWM period.

In an operation S606, the control apparatus may obtain the length value of the next switching PWM period based on the at least one PWM signal.

In an operation S608, the control apparatus may control the xyz phases of the 6-phase motor by using the control duty for the xyz phases and the length value of the next switching PWM period.

In the operation S602, the control apparatus may output a first PWM signal to correspond to a value resulting from an operation (e.g., an AND operation) between the length value of the next switching PWM period and 0xFF, and may output a second PWM signal to correspond to a value resulting from an operation (e.g., an AND operation) between the length value of the next switching PWM period and 0xFF00.

In addition, in the operation S606, the control apparatus may extract an A value from the first PWM signal and a B value from the second PWM signal, and may calculate the length value of the next switching PWM period by performing a bitwise operation of (B<<8)|A.

The control apparatus may further include an operation of calculating the length of the next control period, as the sum of one-half of the length of the current switching PWM period and one-half of the length of the next switching PWM period.

In the operation S608, the control apparatus may output a switching PWM signal by using an up-down counter that increments and then decrements in a switching PWM period, and a register that indicates an edge value, wherein the counting direction of the up-down counter may be switched from incrementing to decrementing at the end point or start point of the control period.

In addition, the control apparatus may further include an operation of outputting a master PWM signal in synchronization with the control period, and, in the operation S608, the counting direction of the up-down counter may be switched from incrementing to decrementing in accordance with the master PWM signal.

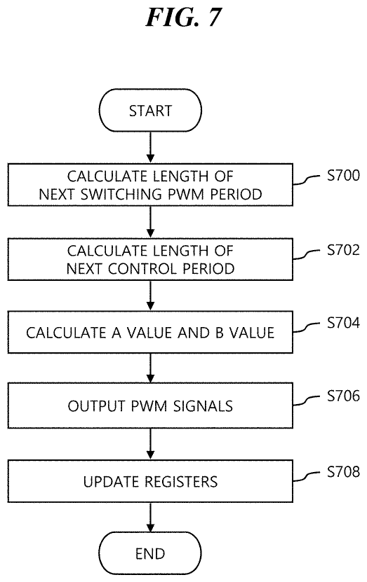

FIG. 7 is a flowchart of a control method for a first controller, according to an embodiment.

Referring to FIG. 7, in operation S700, the first controller may calculate the length of the next switching PWM period.

In an operation S702, the first controller may calculate the length of the next control period, as the sum of one-half of the length of the current switching PWM period and one-half of the length of the next switching PWM period.

In an operation S704, the first controller may calculate an A value and a B value based on the length of the next switching PWM period. The first controller may calculate the A value by performing an operation (e.g., an AND operation) between the length value of the next switching PWM period and 0xFF, and may calculate the B value by performing an operation (e.g., an AND operation) between the length value of the next switching PWM period and 0xFF00 (a bit shift operation may be additionally performed on the B value).

In an operation S706, the first controller may update registers for the A value and the B value, such that one or more PWM signals are output.

In an operation S708, the first controller may update a register for the control period length value and a register for the edge value in the next switching PWM period.

In addition, the first controller may generate and output a switching PWM signal, by using such an edge value and an up-down counter.

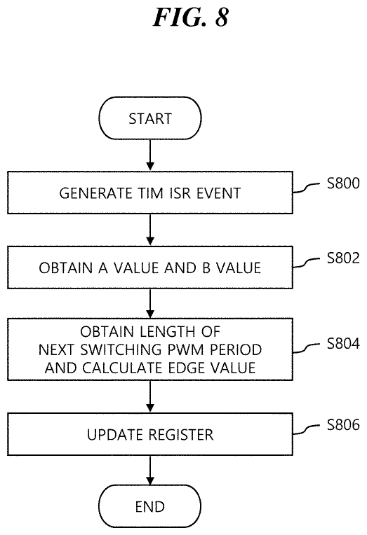

FIG. 8 is a flowchart of a control method for a second controller, according to an embodiment.

Referring to FIG. 8, in an operation S800, a TIM ISR event in the second controller may be generated by a TIM.

In an operation S802, the second controller may read an A value and a B value from PWM signals, via a function that processes a TIM ISR event.

In an operation S804, the second controller may obtain the length of the next switching PWM period by using the A value and the B value, and may calculate an edge value by using the control duty and the length of the next switching PWM period.

In an operation S806, the second controller may update a register for the edge value in the next switching PWM period.

In addition, the second controller may generate and output a switching PWM signal, by using such an edge value and an up-down counter.

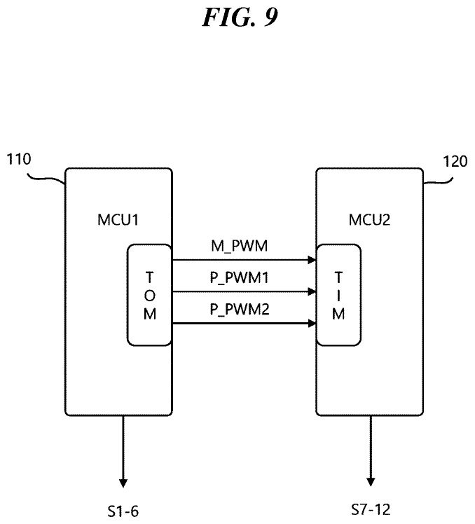

FIG. 9 is a diagram illustrating signals between a first controller and a second controller, according to an embodiment.

Referring to FIG. 9, the first controller 110 may generate switching PWM signals S1 to S6 by using the control duty for the abc phases of the 6-phase motor and the length value of the next switching PWM period, and may control the abc phases of the 6-phase motor by outputting the switching PWM signals S1 to S6 to a first inverter.

In addition, the first controller 110 may output the length value of the next switching PWM period by using a TOM. For example, the first controller 110 may represent, in a first PWM signal P_PWM1 and a second PWM signal P_PWM2, the length value of the next switching PWM period, and may output the first PWM signal P_PWM1 and the second PWM signal P_PWM2 via the TOM.

The second controller 120 may obtain the length value of the next switching PWM period by using a TIM that receives the output of the TOM as an input.

In addition, the second controller 120 may generate switching PWM signals S7 to S12 by using the control duty for the xyz phases of the 6-phase motor and the length value of the next switching PWM period, and may control the xyz phases of the 6-phase motor by outputting the switching PWM signals S7 to S12 to a second inverter.

The first controller may calculate a rising edge tick value or a falling edge tick value of a switching PWM signal, by using the control duty for the abc phases and the length value of the next switching PWM period. In addition, the second controller may calculate a rising edge tick value or a falling edge tick value of a switching PWM signal, by using the control duty for the xyz phases and the length value of the next switching PWM period.

The first controller and the second controller may output switching PWM signals by using an up-down counter that increments and then decrements in a switching PWM period, and a register that indicates a rising edge tick value or a falling edge tick value.

The first controller may further output a control period by using the TOM. This signal may be the master PWM signal M_PWM. In addition, the second controller may switch the counting direction of the up-down counter from incrementing to decrementing at the end point or start point of the control period, which is identified by the TIM.

In addition, an ISR event corresponding to the end point or start point of the control period may be generated by the TIM in the second controller.

The first controller may output the length value of the next switching PWM period, as a plurality of PWM signals by using the TOM. For example, as illustrated in FIG. 9, the first controller may output the length value of the next switching PWM period, as the first PWM signal P_PWM1 and the second PWM signal P_PWM2.

As described above, according to embodiments of the present disclosure, a motor may be controlled more safely. In addition, according to embodiments of the present disclosure, by controlling a 6-phase motor via a dual controller, the safety of 6-phase motor control may be further enhanced. In addition, according to embodiments of the present disclosure, the synchronization problem, a challenge associated with a dual controller, may be addressed.

The terms such as “include,” “comprise,” or “have” described above mean that the corresponding component may be inherent as long as there is no particular opposing recitation, and thus, it should be interpreted that other components may be further included rather than excluded. All terms used herein, including technical and scientific terms, have the same meaning as commonly understood by those of skill in the art, unless defined otherwise. Terms, such as those defined in commonly used dictionaries, should be interpreted as having a meaning that is consistent with their meaning in the context of the relevant art and the present disclosure, and should not be interpreted in an idealized or overly formal sense unless expressly so defined herein.

The above description merely explains the technical idea of the present disclosure and the present disclosure may be changed and modified in various ways by those having ordinary skill in the art without departing from the scope of the present disclosure. Accordingly, the embodiments described herein are provided not to limit, but to merely explain the technical idea of the present disclosure, and the technical idea of the present disclosure is not limited by the embodiments. The scope of the present disclosure should be construed by the following claims, and all technical ideas within the equivalent scope should be construed as being included in the scope of the present disclosure.

What is claimed is:

1. An apparatus for synchronously controlling a 6-phase motor, the apparatus comprising:
a first controller configured to:
calculate a length of a next switching pulse-width modulation (PWM) period,
output at least one PWM signal indicating a length value of the next switching PWM period, and
control abc phases of the 6-phase motor by using a control duty for the abc phases and the length value of the next switching PWM period; and
a second controller configured to:
obtain the length value of the next switching PWM period according to the at least one PWM signal, and
control xyz phases of the 6-phase motor by using a control duty for the xyz phases and the length value of the next switching PWM period.

2. The apparatus of claim 1, wherein the first controller is further configured to:
divide the length value of the next switching PWM period into lower bit values and upper bit values;
output a first PWM signal indicating the lower bit values; and
output a second PWM signal indicating the upper bit values.

3. The apparatus of claim 2, wherein the second controller is further configured to:
extract an A value from the first PWM signal;
extract a B value from the second PWM signal; and
obtain the length value of the next switching PWM period by performing an OR operation between a value resulting from a bit shift operation on the B value, and the A value.

4. The apparatus of claim 1, wherein the first controller and the second controller are further configured to output a switching PWM signal by using i) an up-down counter configured to increment and then decrement in a switching PWM period and ii) a register that indicates an edge value.

5. The apparatus of claim 4, wherein, in the first controller and the second controller, the up-down counter is further configured to switch a counting direction from incrementing to decrementing, according to a master PWM signal that indicates a control period of the first controller.

6. The apparatus of claim 5, wherein a next control period of the first controller is calculated as a sum of one-half of a length of a current switching PWM period and one-half of a length of the next switching PWM period.

7. The apparatus of claim 1, wherein:
the first controller is further configured to output the at least one PWM signal by using a timer output module (TOM); and
the second controller is further configured to extract data for calculating the length value of the next switching PWM period, from the at least one PWM signal by using a timer input module (TIM).

8. The apparatus of claim 7, wherein:
the TIM of the second controller is configured to generate an interrupt service routine (ISR) event according to a master PWM signal or the at least one PWM signal received from the first controller; and
the second controller is further configured to calculate the length of the next switching PWM period, from the data extracted from the at least one PWM signal, according to the ISR event.

9. A method for synchronously controlling a 6-phase motor, the method comprising:
calculating a length of a next switching pulse-width modulation (PWM) period;
outputting at least one PWM signal indicating a length value of the next switching PWM period;
controlling abc phases of the 6-phase motor by using a control duty for the abc phases and the length value of the next switching PWM period;
obtaining the length value of the next switching PWM period according to the at least one PWM signal; and
controlling xyz phases of the 6-phase motor by using a control duty for the xyz phases and the length value of the next switching PWM period.

10. The method of claim 9, wherein outputting the at least one PWM signal indicating the length value of the next switching PWM period includes:
outputting a first PWM signal to correspond to a value resulting from an operation between the length value of the next switching PWM period and 0xFF; and
outputting a second PWM signal to correspond to a value resulting from an operation between the length value of the next switching PWM period and 0xFF00.

11. The method of claim 10, wherein obtaining the length value of the next switching PWM period according to the at least one PWM signal includes:
extracting an A value from the first PWM signal, extracting a B value from the second PWM signal; and
calculating the length value of the next switching PWM period by performing a bitwise operation of (B<<8)|A.

12. The method of claim 9, further comprising calculating a length of a next control period as a sum of one-half of a length of a current switching PWM period and one-half of the length of the next switching PWM period.

13. The method of claim 12, wherein controlling the xyz phases includes:
outputting a switching PWM signal by using i) an up-down counter configured to increment and then decrement in a switching PWM period and ii) a register that indicates an edge value; and
switching a counting direction of the up-down counter from incrementing to decrementing, at an end point or a start point of the next control period.

14. The method of claim 13, further comprising outputting a master PWM signal in synchronization with the control period,
wherein controlling the xyz phases includes switching the counting direction of the up-down counter from incrementing to decrementing, according to the master PWM signal.

15. An apparatus for synchronously controlling a 6-phase motor, the apparatus comprising:
a first controller configured to:
control abc phases of the 6-phase motor by using a control duty for the abc phases and a length value of a next switching pulse-width modulation (PWM) period, and
output the length value of the next switching PWM period by using a timer output module (TOM); and
a second controller configured to:
obtain the length value of the next switching PWM period by using a timer input module (TIM) configured to receive an output of the TOM as an input, and
control xyz phases of the 6-phase motor by using a control duty for the xyz phases and the length value of the next switching PWM period.

16. The apparatus of claim 15, wherein the second controller is further configured to calculate a rising edge tick value or a falling edge tick value of a switching PWM signal by using the control duty for the xyz phases and the length value of the next switching PWM period.

17. The apparatus of claim 16, wherein the second controller is further configured to output the switching PWM signal by using i) an up-down counter configured to increment and then decrement in a switching PWM period and ii) a register that indicates the rising edge tick value or the falling edge tick value.

18. The apparatus of claim 17, wherein:
the first controller is further configured to further output a control period by using the TOM; and
the second controller is further configured to switch a counting direction of the up-down counter from incrementing to decrementing, at an end point or a start point of the control period, which is identified by the TIM.

19. The apparatus of claim 18, wherein an interrupt service routine (ISR) event corresponding to the end point or the start point of the control period is generated by the TIM in the second controller.

20. The apparatus of claim 15, wherein the first controller is further configured to output the length value of the next switching PWM period, as a plurality of PWM signals by using the TOM.
